(19) United States
(12) Patent Application Publication
(10) Pub. No.: US 2006/0075433 A1
(43) Pub. Date: Apr. 6, 2006

(54) System and method for detecting services which can be provided by at least two different services sources

(75) Inventor: Laurent Gardes, Boulogne-Billancourt (FR)

Correspondence Address: PHILIPS INTELLECTUAL PROPERTY & STANDARDS, P.O. BOX 3001, BRIARCLIFF MANOR, NY, 10510, US

(73) Assignee: KONINKLIJKE PHILIPS ELECTRONICS, N.V., Eindhoven (NL)

(21) Appl. No.: 10/536,966

(22) PCT Filed: Nov. 24, 2003
(86) PCT No.: PCT/IB03/05491

§ 371 Date: May 31, 2005

(30) Foreign Application Priority Data
Dec. 4, 2002 (FR) 02/15291

(51) Int. Cl. H04N 5/445; G06F 13/00; G06F 3/00

(52) U.S. Cl. 725/48; 725/39

(57) ABSTRACT

The system (16) for detecting services which can be provided by at least two different service sources (22, 24, 26, 28) comprises: —means (32, 34, 38, 40) for acquiring information concerning services supplied by at least two sources in at least two different service description formats; —means (38, 40) for converting, into one and the same common service description format, information acquired in a service description format which is different from the common service description format; and —means (30, 32, 42) for putting information at the disposal of a user, concerning services in the common description format adapted for a presentation of information in a unified form.

### FIELD OF THE INVENTION

The invention relates to a system and a method for detecting services provided by at least two different service sources.

The invention also relates to a computer program for using such a method, and to a decoder using this method.

The words “program” and “service” will hereinafter be used indifferently to designate a sequence of images and/or sounds which can be recovered by an adapted reproduction device.

### BACKGROUND OF THE INVENTION

The current equipment for putting audiovisual programs at the disposal of users, such as digital television systems, are capable of receiving programs or services from numerous different sources. These services may be provided by broadcasters establishing a data stream from a satellite or via a cable network. They may also be provided via the Internet after connection to a transmitter site, or by reading data on a local or distant data carrier such as a hard disk.

The user of such a digital television system has the disposal of means allowing the detection of services. These means provide information on the services such as the broadcast timetable, the duration of the program, its title and a summary of the contents in order that the user can choose the desired service from those that are at his disposal.

However, each service source uses a specific protocol for providing information concerning the proposed services. Particularly, service description formats which are typical of each source are used. The service description format specifies the nature of the provided information, as well as its structure.

Each service source thus necessitates the use of a system for detecting services suitable for use in the receiving equipment. The interfaces allowing the provision of information on the services are also typical of each service source. The user should thus use a first system using a first interface so as to know the services provided by the broadcasters to which he is subscribed, a second system with a second interface to know the services proposed via the Internet by connection to dedicated servers, and other systems with other interfaces to know the services proposed by the local or distant databases stored on hard disks.

Getting to know the different proposed services is delicate for the user because the systems for detecting services differ as a function of the type of source and notably the used communication protocol.

Moreover, the digital television system must comprise the different systems for detecting services in order to enable the user to have knowledge of all the services that are proposed to him.

The structure of the television system is therefore very sophisticated and thus costly.

### OBJECT AND SUMMARY OF THE INVENTION

It is an object of the invention to provide a system for detecting digital television services which can be used in a simple manner and are convenient to the user.

To this end, the invention relates to a system for detecting services which can be provided by at least two different service sources, the system comprising:
means for acquiring information concerning services supplied by at least two sources in at least two different service description formats;
means for converting, into one and the same common service description format, information acquired in a service description format which is different from the common service description format; and
means for putting information at the disposal of a user, concerning services in the common description format adapted to present information in a unified form.

In accordance with a particular embodiment, the device has one or several of the following characteristics features:
it comprises a module for managing information concerning services in the common service description format;
it comprises a database interfaced with the managing module for storing information in the common description format;
the common service description format is the SDP-NG format;
the means put at the disposal of the user comprise a module for converting information for the common description service format into an exploitation format, and an electronic program guide module adapted to present information concerning the services in the exploitation format in accordance with said unified form;
it comprises a processing module suitable for receiving information concerning services directly in the exploitation format, and said processing module is interfaced with the electronic program guide module for presenting, to the user, information concerning services in the exploitation format in accordance with said unified form; and
said exploitation format is the service description format based on the DVB-SI protocol.

It is also an object of the invention to provide a decoder for receiving digital television services, and is characterized in that it comprises a system for detecting services as defined hereinbefore.

It is another object of the invention to provide a method of detecting services which can be provided by at least two different service sources, and is characterized in that it comprises the steps of:
acquiring information concerning services supplied by at least two sources in two different service description formats; and
converting, into one and the same common service description format, information acquired in a service description format which is different from the common service description format; and
putting information at the disposal of a user, concerning services in the common description format in accordance with a presentation of the information in a unified form.

It is a further object of the invention to provide a computer program product comprising a set of instructions for performing the steps of the method described hereinbefore, when said computer program is used by data processing means.

### BRIEF DESCRIPTION OF THE DRAWINGS

The invention will be better understood by reading the following description given solely by way of example and with reference to the drawings, in which:

FIG. 1 is a diagrammatic view of a digital television receiving system using a system for detecting services according to the invention; and

FIGS. 2 and 3 are diagrams illustrating the data streams between the different units of the system for detecting services according to the invention.

### DESCRIPTION OF EMBODIMENTS

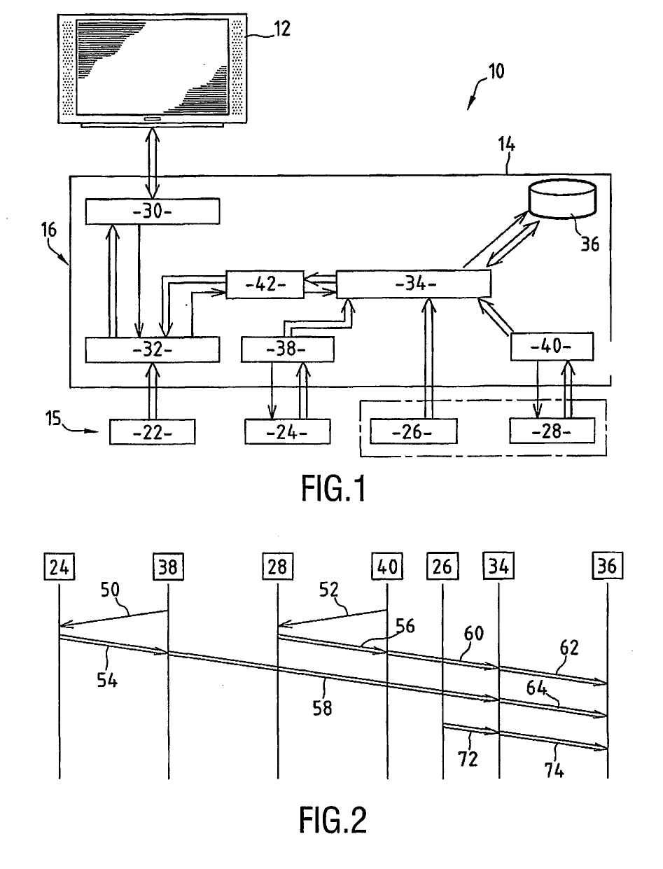

FIG. 1 shows a digital television installation 10.

As is known per se, this installation comprises a television 12 connected to a decoder 14 which in turn is connected to an assembly 15 of program or service sources.

The decoder 14 comprises means for decoding and conditioning data received from different service sources so as to put these data in a form in which they can be used by the television 12, notably with a view to display on the screen and the control of sound reproduction.

These means for decoding and conditioning the received data are known and will not be further described.

Moreover, the decoder 14 comprises a system for detecting services, denoted by the general reference numeral 16. According to the invention, this detection system is adapted to acquire information from several service sources in different description formats and to allow the information to be put at the disposal of a user in accordance with a unified presentation, irrespective of its original description format.

These service sources comprise, for example, a source 22 for permanently broadcasting programs, to which source the decoder is connected, for example, via a satellite receiver, or a connection to a cable network for broadcasting programs.

This broadcasting source periodically addresses information to the decoder 14 concerning the services proposed in a suitable service description format defined by the DVB-SI protocol (Digital Video Broadcasting Section Information). This information is given in SI (Section Information) tables and notably in SDT (Service Description Table) and EIT (Event Information Table) tables.

The DVB-SI protocol is specified by the DVB (Digital Video Broadcasting) standardization group.

The decoder 14 is also connected to a second local source 24. This source is constituted, for example, by a hard disk on which a set of video programs is stored. The information concerning these programs accessible on the hard disk. It is stored in an appropriate service description format defined by the NFS (Network File System) protocol.

The decoder 14 is also connected via the Internet to a first server 26. This server is adapted to provide information to the decoder 14 concerning the accessible services by using the SDP-NG (Service Description Protocol-Next Generation) service description format used in conjunction with the SAP (Session Announcement Protocol) protocol.

The SDP-NG service description format is proposed by the DVB-IPI (Digital Video Broadcasting on Internet Protocol Infrastructure) standardization group.

The decoder 14 is suitable for receiving, via the Internet, information from a second server 28 using, as a proposed service description format, a format authorized by the RTSP (Real-Time Streaming Protocol) protocol. The RTSP protocol authorizes several types of service description formats, notably SDP-NG, SDP or XML.

To ensure the detection of services, the system 16 comprises an EPG (Electronic Program Guide) module 30. This EPG module 30 is notably adapted to allow the formulation of a request by a user wishing to be informed on the services available from each source. This request is notably formulated by scrolling through menus by means of a remote control. The module 30 ensures the reception and processing of information concerning available services, which information is in the service description format that is suitable for the DVB-SI protocol. This description format constitutes an exploitation format.

The module 30 is suitable for ensuring, under the control of the user, a presentation and notably a display of information concerning the services that are accessible on the screen of the television 12. This information is provided in a unified form, irrespective of the source of origin. The provision in a unified form means that the information, irrespective of its origin, can be requested via the same interrogation interface and is displayed in the same order, the same presentation and use of the same graphic card.

The service detection system comprises a module 32 for processing information in the service description format suitable for the SI protocol which is interfaced with the EPG module 30. This processing module 32 is suitable for receiving requests from the EPG module 30 in the JAVA TV language as defined in the DVB-MHP (Multimedia Home Platform) standard.

The processing module 32 is particularly adapted to receive information from the source 22 during each periodical update defined by the DVB-SI protocol. Subsequent to a request, the module 32 is suitable for addressing the program information concerning the source 22 to the EPG module 30.

Moreover, the service detection system 16 comprises a module 34 for managing information in the SDP-NG format for the service description. This managing module 34 will be denoted as SDP-NG managing module in the following description.

This managing module 34 is interfaced with a database 36 integrated with the decoder 14 and adapted to store information concerning services provided by the source 24, 26 or 28. All of this information is stored in the SDP-NG service description format. This format constitutes a service description format which is common for storing information relating to several different sources.

The SDP-NG managing module 34 comprises means for recording information in the database 36 and for searching and reading such information. It is also adapted to directly receive information in the SDP-NG format provided by the source 26 using the SAP protocol when the decoder 14 is connected to this source.

The detection system 16 comprises a module 38 for processing information supplied by the source 24 constituted by storage means such as a hard disk. This information concerning the services is received in the service description format for the NFS (Network File System) protocol.

This processing module 38, referred to as NFS processing module, is suitable for regularly addressing requests in accordance with the NFS protocol to the source 24 with a view to receiving information on the services proposed by this source.

The NFS processing module 38 comprises means ensuring a conversion of information received in a service description format suitable for the NFS protocol into information in the SDP-NG format.

Similarly, the detection system 18 comprises a processing module 40 suitable for communicating with the service sources using the RTSP protocol.

This processing module 40, referred to as RTSP processing module, is particularly adapted to regularly address requests to the source 28 for obtaining information concerning the services provided and for acquiring and processing this information received in one of the service description formats used by the RTSP protocol.

The processing module 40 is also adapted to ensure a conversion of information concerning the service description formats used by the RTSP protocol into information in the SDP-NG format.

The NFS and RTSP processing modules 38 and 40 are both interfaced with the SDP-NG managing module 34 so as to periodically provide to this module the information concerning the services proposed by the sources 24 and 28. This information is provided to the SDP-NG managing module in the SDP-NG service description format.

Finally, the detection system 18 comprises a module 42 for converting information concerning services in the SDP-NG service description format into information in the service description format used in the DVB-SI protocol. This module 42 is interfaced with the managing module 34 and the SI processing module 32 so as to acquire information in the SDP-NG format from the managing module 34 and address this information, after conversion, to the SI processing module 32.

Moreover, the SI processing module is suitable for formulating requests and for addressing these requests to the conversion module 42. These requests are intended to acquire information concerning the services proposed by the sources 24, 26 and 28. These requests are intended to be transmitted to the SDP-NG managing module 34 by the conversion module 42 in order to search the information corresponding to the requests in the base 36.

The functions of the different modules constituting the service detection system 16 are ensured by digital processing operations performed by a computer such as a microprocessor using specific programs whose principal functions will be described hereinafter.

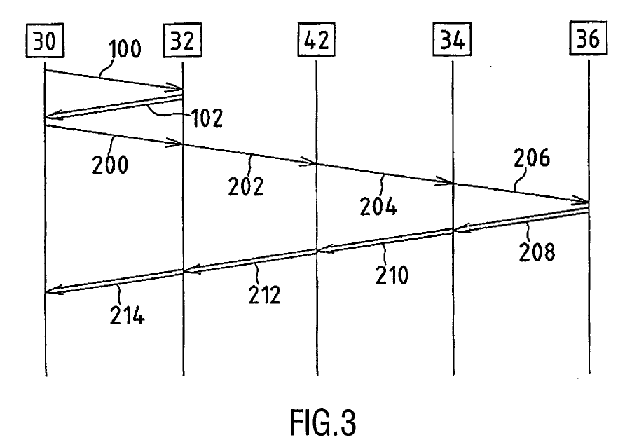

FIGS. 2 and 3 are diagrams illustrating the operation of the service detection system in different phases of operation.

During operation of the digital television receiving system, the processing modules 38 and 40 request, at a regular frequency, the information concerning the services proposed by the sources 24 and 28, respectively. They address this information after conversion into the SDP-NG format to the managing module 34. The latter ensures an update of the database 36 on the basis of information received from the processing modules 38 and 40.

To this end, and as illustrated in FIG. 2, the modules 38 and 40 address requests 50, 52 to the sources 24 and 28, respectively, in accordance with the respective NFS and RTSP protocols. The latter return information messages 54, 56 to the modules 38 and 40. The modules 38, 40 ensure a conversion of the information received in the SDP-NF service description format. This information is communicated at 58, 60 to the managing module 34. The latter ensures saving of the information in the storage means 36 via the data streams 62, 64.

The source 26 regularly addresses the information in the SDP-NG format in the message 72 to the managing module 34. This information 74 is then stored in the database 36 by the SDP-NG managing module 34.

The message is communicated by using the SAP protocol.

The user wishing to be informed about services proposed by the different sources addresses a request designating the source to the decoder 14, for example, by means of a remote control. This phase of operation is illustrated in FIG. 3.

If the selected source is the source 22, the EPG module 30 then addresses a request 100 to the SI processing module 32, which returns a message 102 to the EPG module, which message comprises the last received information concerning the services provided by the source 22.

In contrast, if the request by the user concerns one of the sources 24, 26 and 28, as illustrated in the lower part of FIG. 3, the EPG module 30 addresses a request 200 to the SI processing module 32 which transmits a corresponding request 202 to the conversion module 42 which itself addresses the same request 204 to the managing module 34. The latter interrogates the base 36 by means of a request 206 and in return acquires the searched information 208. This information is returned to the conversion modules 42 and 210. The latter ensures conversion of this information into the format suitable for the DVB-SI protocol and its communication at 212 to the processing module 32. The information is then transmitted at 214 by the processing module 32 to the EPG module 30 with a view to putting it at the disposal of the user.

It is conceivable that such a service detection system allows information to be put at the disposal of the user, concerning the services in a unified form, irrespective of the source from which these services originate, even if these sources use different protocols employing different service description formats.

The presence of means for converting information in different service description formats into one and the same common service description format allows the use of one and the same electronic program guide whose management is simplified and can easily be stored by the user without having to use several different service detection systems as a function of the source from which the services originate.

The solution according to the invention is particularly economical because it can be used with the current “EPG” electronic program guides based on MHP, JAVA TV, and thus on DVB-SI without having to be modified. This is possible by virtue of the unified format which is transformed by the module 42 into the conventional SI table (EIT) at the request of the electronic program guide.

1. A system for detecting services which can be provided by at least two different service sources, the system comprising:
means for acquiring information concerning services supplied by at least two sources in at least two different service description formats;
means for converting, into one and the same common service description format, information acquired in a service description format which is different from the common service description format; and
means for putting information at the disposal of a user, concerning services in the common description format adapted to present information in a unified form.

2. A system for detecting services as claimed in claim 1, characterized in that it comprises a module for managing information concerning services in the common service description format.

3. A system for detecting services as claimed in claim 2, characterized in that it comprises a database interfaced with the managing module for storing information in the common description format.

4. A system for detecting services as claimed in claim 1, characterized in that the common service description format is the SDP-NG format.

5. A system for detecting services as claimed in claim 1, characterized in that the means put at the disposal of the user comprise a module for converting information for the common description service format into an exploitation format, and a module forming an electronic program guide adapted to present information concerning the services in the exploitation format in accordance with said unified form.

6. A system for detecting services as claimed in claim 5, characterized in that it comprises a processing module suitable for receiving information concerning services directly in the exploitation format, and in that said processing module is interfaced with the electronic program guide module for presenting, to the user, information concerning services in the exploitation format in accordance with said unified form.

7. A system for detecting services as claimed in claim 5, characterized in that said exploitation format is the service description format based on the DVB-SI protocol.

8. A decoder for receiving digital television services, characterized in that it comprises a system for detecting services as claimed in claim 1.

9. A method of detecting services which can be provided by at least two different service sources, characterized in that the method comprises the steps of:
acquiring information concerning services supplied by at least two sources in two different service description formats; and
converting, into one and the same common service description format, information acquired in a service description format which is different from the common service description format; and
putting information at the disposal of a user, concerning services in the common description format in accordance with a presentation of the information in a unified form.

10. A computer program product comprising a set of instructions for performing the steps of the method as claimed in claim 9, when said computer program is used by data-processing means.
